(19) United States
(12) Patent Application Publication
(10) Pub. No.: US 2013/0305353 A1
(43) Pub. Date: Nov. 14, 2013

(54) Low Power Driver System and Method for Controlling The Same

(71) Applicant: RUTHERFORD CONTROLS INTERNATIONAL CORP., Ontario (CA)

(72) Inventors: Ryan McMillan, Ontario (CA); Pete Robinson, Hatfield Broad Oak (GB)

(73) Assignee: Rutherford Controls International Corp., Ontario (CA)

(21) Appl. No.: 13/725,253

(22) Filed: Dec. 21, 2012

Related U.S. Application Data
(63) Continuation-in-part of application No. 13/468,458, filed on May 10, 2012, now abandoned.

(51) Int. Cl. G06F 21/31

(52) U.S. Cl. CPC G06F 21/31
USPC 726/19

(57) ABSTRACT

A low power driver system for controlling an electric strike of a door is provided. The low power driver system includes an input system configured to detect a user credential, a control system configured to authenticate the user credential and generate a plurality of signals based at least in part on an authentication of the user credential, a driver system configured to generate a plurality of voltage potentials during an unlocking cycle based at least in part on the plurality of signals, wherein each of the plurality of voltage potentials are difference from each other, and a locking device configured to unlock based at least in part on the plurality of voltage potentials.

### CROSS-REFERENCE TO RELATED APPLICATIONS

This patent application is a continuation-in-part of U.S. patent application Ser. No. 13/468,458, filed May 10, 2012, which is hereby incorporated by reference herein in its entirety.

### FIELD OF THE DISCLOSURE

The present invention relates generally to a driver system that controls an electric strike of an electronic lock set. More specifically, the present invention relates to a low power driver system that controls an electric strike of an electronic lock set for doors and cabinet.

### BACKGROUND OF THE DISCLOSURE

An electric strike is an access control device used for doors. Generally, an electric strike includes a locking device that can upon command, swing out of the way of the latch to allow the door to be pushed open without retracting the latch. Electric strikes generally come in two basic configurations. First configuration is called fail secure or fail locked, where an electric current is applied to the electric strike to cause the electric strike to open. The fail secure configuration electric strike would remain locked in a power failure but can be opened from the inside of the door. Second electric strike configuration is called fail-safe or fail open, where an electric current is applied to the electric strike to cause the electric strike to close or lock. The fail safe configuration electric strike would remain open during a power failure and the door may be pushed open from inside and/or outside of the door.

The activation and deactivation of an electric strike is controlled by a driver that may allow a user to move the locking device (e.g., keeper) of the electric strike between an open position and a closed position. Conventional drivers used for controlling the electric strike typically require to be driven at a high voltage potential. Also, conventional drivers for controlling the electric strike typically require to be driven at a high voltage potential during an entire cycle of the locking device opening and closing. As a result, the drivers consume extra power, resulting in higher power consumption.

### SUMMARY OF THE DISCLOSURE

Embodiments of the present invention advantageously provide a low power driver system that controls an electric strike of a door. More specifically, one embodiment provides a low power driver system that includes an input system configured to detect a user credential, a control system configured to authenticate the user credential and generate a plurality of signals based at least in part on an authentication of the user credential, a driver system configured to generate a plurality of voltage potentials during an unlocking cycle based at least in part on the plurality of signals, wherein each of the plurality of voltage potentials are different from each other, and a locking device configured to unlock based at least in part on the plurality of voltage potentials.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 depicts a locking system having a low power driver according to an exemplary embodiment of the present disclosure.

FIG. 2 depicts components of the locking system depicted in FIG. 1 according to an exemplary embodiment of the present disclosure.

FIG. 3A illustrates an output voltage potential waveform of the micro-controller according to an exemplary embodiment of the present disclosure.

FIG. 3B illustrates voltage potential waveform of an output of the variable output converter according to an exemplary embodiment of the present disclosure.

FIG. 4 depicts a flow diagram for a method of operating the locking system depicted in FIG. 1 according to an exemplary embodiment of the present disclosure.

### DETAILED DESCRIPTION OF EMBODIMENTS

The invention will now be described with reference to the drawing figures, in which like reference numerals refer to like parts throughout.

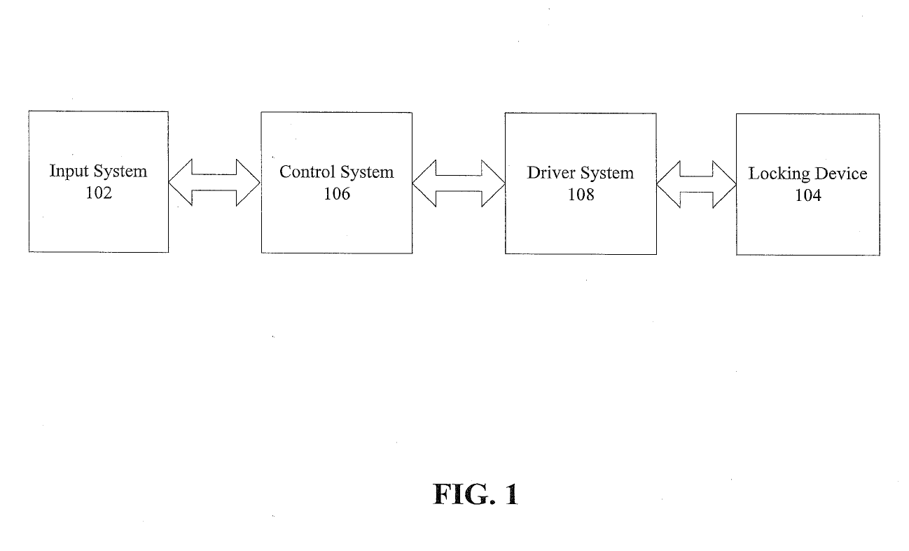

FIG. 1 illustrates a locking system having a low power driver system, in accordance with an exemplary embodiment of the present disclosure. The locking system 100 may include a user input system 102 coupled to a locking device 104 via a control system 106 and a driver system 108. During operation, the input system 102 may receive user credentials from a user to access the locking device 104. The input system 102 may provide the user credential to the control system 106 in order to authenticate the user credential. For example, the control system 106 may compare and contrast the received user credential with valid user credentials stored in the control system 106 in order to identify whether the received user credential matches a valid user credential stored in the control system 106. Once the control system 106 authenticates the received user credential, the control system 106 may provide one or more unlocking signals to the driver system 108. The driver system 108 may provide a plurality of voltage potentials to the locking device 104 during an unlocking cycle (e.g., 5 seconds may be the time period where locking device 104 is unlocked).

In an exemplary embodiment, the one or more unlocking signals provided by the control system 106 may control a time period of an unlocking cycle of the driver system 108. The control system 106 may generate different unlocking signals based at least in part on dual in-line (DIP) switches, programming cards, or potentiometer and/or other devices. For example, a first unlocking signal generated by the control system 106 may unlock the driver system 108 for 5 seconds unlocking cycle while a second unlocking signal generated, by the control system 106 may unlock the driver system 108 for 10 seconds unlocking cycle.

For example, the driver system 108 may provide an initiation voltage potential to unlock the locking device 104 (e.g., an unlocked state). The driver system 108 may also provide a holding voltage potential to maintain the locking device 104 in the unlocked state. During the application of the holding voltage potential, the locking device 104 may gradually return to a locked state and the driver system 108 may provide a refresh voltage potential to restore the locking device 104 to the unlocked state. The initiation voltage potential, the holding voltage potential and the refresh voltage potential may be different from each other. For example, the driver system 108 may reduce power consumption by providing different voltage potentials to the locking device 104 during an unlocking cycle (e.g., 5 seconds). In an exemplary embodiment, the holding voltage potential may be lower than the initiation voltage potential and/or the refresh voltage potential. In another exemplary embodiment, the refresh voltage potential may be higher than the holding voltage potential but lower than the initiation voltage potential. In other exemplary embodiments, the refresh voltage potential may be the same as the initiation voltage potential.

The input system 102 may include a keypad, a proximity reader, a magnetic stripe card reader, a barcode reader, a photo scanner, a radio frequency identification (RFID) reader, a biometric scanner, a smart card reader, a Wiegand interface and/or other readers or scanners that may identify user authentication information.

The locking device 104 may include an electro-magnetic locking device, an electric strike locking device, a mortise locking device with offset latches, a mortise exit device, a cylindrical locking device, American National Standard Institute (ANSI) frame locking devices, a solenoid locking device and/or any other electric locking devices.

The control system 106 may include a peripheral interface controller (PIC), a reduced instruction set computing (RISC) processor, Alpha processor, AMD 29K processor, an ARC processor, an ARM processor, an AVR processor, a blackfin processor, a microprocessor without interlocked pipeline stages (MIPS), a precision architecture processor, a power architecture processor, a SuperH processor, a scalable processor architecture (SPARC) processor, a load-store architecture processor and/or other controller that may control an operation of the driver system 108.

The control system 106 may also include one or more storage devices including, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other storage devices.

The driver system 108 may include a driver circuitry that may provide a plurality of voltage potentials to the locking device 104. In an exemplary embodiment, the driver system 108 may include a buck-boost converter that has an output voltage potential that is either greater than or less than the input voltage potential.

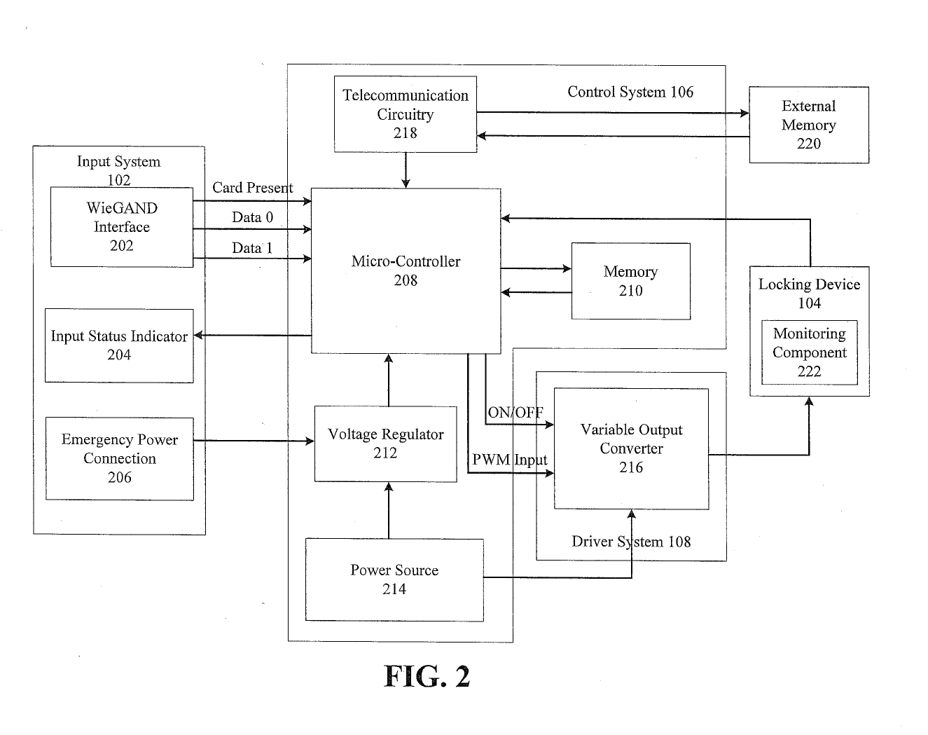

FIG. 2 illustrates components of a locking system, in accordance with an exemplary embodiment of the present disclosure. The input system 102 may include a Wiegand interface 202, an input status indicator 204 and an emergency power connection 206. The locking device 104 may include a monitoring component 222 that may monitor an unlocking time period of the locking device 104. The control system 106 may include a micro-controller 208, a memory 210, a voltage regulator, 212, a power source 214, and a telecommunication circuitry 218. The driver system 108 may include a variable output converter 216. The power source 214 may be located on a secure side of the door and may provide power to the Wiegand interface 202 and the micro-controller 208 in order to power the locking system 100. The power source 214 may be an alternating current (AC) source or a direct current (DC) source. In an exemplary embodiment, the power source 214 may be a portable power source (e.g., battery). In another exemplary embodiment, the power source 214 may include energy harvesting circuitry (e.g., electromagnetic or piezoelectric) or super capacitors that may allow the control system 106 to operate without a portable power source (e.g., battery). The power source 214 may provide power to the Wiegand interface 202 and the micro-controller 208 via the voltage regulator 212. The voltage regulator 212 may control the voltage potential supplied to the Wiegand interface 202 and the micro-controller 208. The emergency power connection 206 may be located on an unsecure side of the door and may provide power to the locking system 100 when the power source 214 fails. Also, during an emergency (e.g., fire or any other hazard) where the power source 214 fails, the emergency power connection 206 may notify the voltage regulator 212 to supply power or cutoff the power source 214.

The Wiegand interface 202 may be any detection or reader system that uses wiegand wiring standard based on the Wiegand effect. In an exemplary embodiment, the Wiegand interface 202 may use a three wire standard, where a first wire is coupled to the ground and a second wire and a third wire are configured to transmit data to the micro-controller 208. For example, the second wire may be a Data 0 wire or data low wire and the third wire may be a Data 1 wire or data high wire. The Data 0 wire and the Data 1 wire may be coupled to the micro-controller 208 of the control system 106. When no data are transmitted by the Wiegand interface 202, the Data 0 wire and the Data 1 wire may be biased to a high voltage potential (e.g., 5V). When a binary state 0 (e.g., logic low) is transmitted by the Wiegand interface 202, the Data 0 wire may be biased to a low voltage potential while the Data 1 wire may maintain the high voltage potential (e.g., 3.3V). When a binary state 1 (e.g., logic high) is transmitted by the Wiegand interface 202, the Data 1 wire may be biased to a low voltage potential while the Data 0 wire may maintain the high voltage potential (e.g., 3.3V).

During operation of the locking system 100, a user may present user credential to the Wiegand interface 202 that may operate in a Wiegand communication protocol. In an exemplary embodiment, a user may present an identification card having a radio frequency identification (RFID) chip or low energy radio frequency (RF) transceiver embedded within. The embedded RFID chip may indicate an encoded key of the user's credential information. The Wiegand interface 202 may detect a presence of an identification card and may transmit a card present signal to the micro-controller 208 to wake the micro-controller 208 from a “sleep mode.” In an exemplary embodiment, the micro-controller 208 may be resting in a “sleep mode” in order to reduce power consumption. The card presence signal may cause the micro-controller 208 to switch from the “sleep mode” to the “operation mode.” The Wiegand interface 202 may also provide user credential to the micro-controller 208 via the Data 0 wire and the Data 1 wire. In an exemplary embodiment, a user may swipe an identification card having embedded RFID chip through a slot of the Wiegand interface 202 to identify a binary code that may represent the user's credential information. The binary code may be encoded user credential that may be transmitted to the micro-controller 208 via the Data 0 wire and the Data 1 wire.

The micro-controller 208 may authenticate the received user credential by comparing and contrasting the received user credential with valid user credentials stored at a memory 210 of the control system 106. For example, the memory 210 may store valid user credentials of users that may be allowed to unlock the locking device 104. The valid user credentials stored in the memory 210 may be periodically updated, for example, adding user credentials and/or deleting user credentials. The micro-controller 208 may compare the received user credential with the valid user credentials stored in the memory 210 in order to determine whether the received user credential matches a valid user credential stored in the memory 210. In the event that the received user credential does not match a valid user credential stored in the memory 210, the micro-controller 208 may provide a fail indication signal to the input status indicator 204 to notify the user that an access has been denied. The micro-controller 208 may switch to “sleep mode” if no more attempts to access the locking device 104 within a period of time (e.g., 5 seconds). Also, the micro-controller 208 may switch to “sleep mode” when the micro-controller 208 finishes performing an operation (e.g., open operation or close operation).

The memory 210 may store access information associated with the locking device 104. For example, the memory 210 may store user credentials, a number of attempts, and a time of a user accessing the locking device 104 to allow security audit of the locking device 104. Also, the memory 210 may store time of maintenance services and time of tempering the locking device 104. The access information may allow a security personnel to audit who and when accessed the locking device 104. The access information stored in the memory 210 may be downloaded to an external memory device 220 (e.g., secure digital (SD) card or universal serial bus (USB) memory).

The telecommunication circuitry 218 (e.g., Bluetooth or Wi-Fi circuitry) may enable a user to communicate with various components of the control system 106. For example, the telecommunication circuitry 218 may transmit information to and from the control system 106. In an exemplary embodiment, the telecommunication circuitry 218 may allow a user to add user credential information to the memory 210 or delete user credential information stored in the memory 210. In another embodiment, the access information stored in the memory 210 may be transmitted to the external memory device 220 via the telecommunication circuitry 218.

In the event that the received user credential matches a valid user credential, the micro-controller 208 may provide an access signal to the variable output converter 216. The access signal may switch the variable output converter 216 to an “operation mode.” For example, the variable output converter 216 may be resting in a “sleep mode” and the access signal may switch the variable output converter 216 from the “sleep mode” to the “operation mode.” The micro-controller 208 may also provide a plurality of drive signals to the variable output converter 216 to unlock the locking device 104 for a period of time (e.g., 5 seconds). The micro-controller 208 may provide different drive signals to the variable output converter 216 to adjust an unlocking time period of the locking device 104. In an exemplary embodiment, the micro-controller 208 may provide a plurality of pulse-width modulation (PWM) signals to the variable output converter 216 in order to unlock the locking device 104. The plurality of access signals provided by the micro-controller 208 may control an output voltage potential of the variable output converter 216 in order to reduce power consumption.

For example, the micro-controller 208 may control a duty cycle of the plurality of access signals provided to the variable output converter 216. In an exemplary embodiment, the plurality of access signals provided by the micro-controller 208 may have a frequency in a range of 10 kHz to 100 kHz. By varying the duty cycle of the plurality of access signals, the micro-controller 208 may directly control the output voltage potential of the variable output converter 216. The micro-controller 208 may increase a duty cycle of the plurality of access signals in order to increase an output voltage potential of the variable output converter 216. The micro-controller 208 may decrease a duty cycle of the plurality of access signals in order to decrease an output voltage potential of the variable output converter 216.

In an exemplary embodiment, the micro-controller 208 may provide three different access signals having different duty cycles to the variable output converter 216 to control output voltage potentials outputted by the variable output converter 216 to the locking device 104. For example, the micro-controller 208 may provide an initiation signal to the variable output converter 216 to cause the variable output converter 216 to output an initiation voltage potential to the locking device 104. The initial voltage potential may unlock the locking device 104. In an exemplary embodiment, the initiation voltage potential may be approximately 9.0V. The micro-controller 208 may provide a holding signal to the variable output converter 216 to cause the variable output converter 216 to output a holding voltage potential. The holding voltage potential may maintain the locking device 104 unlocked. In an exemplary embodiment, the holding voltage potential may be approximately 2.0V. The micro-controller 208 may provide a refresh signal to the variable output converter 216 to cause the variable output converter 216 to output a refresh voltage potential. The refresh voltage potential may unlock the locking device 104 in the event that the holding voltage potential may not be sufficient to maintain the locking device 104 unlocked. In an exemplary embodiment, the refresh voltage potential may be approximately 6.0V. It should be appreciated by one of skilled in the art that the output voltage potential of the variable output converter 216 may vary depending on an amount of voltage potential required to drive different locking devices 104.

By varying an amount of the voltage potential applied to the locking device 104, the amount of power consumption may be reduced. For example, instead of applying a constant high voltage potential (e.g., 12V) to maintain the locking device 104 unlocked, the micro-controller 208 may apply a plurality of lower voltage potentials (e.g., holding voltage potential 2.0V and/or refresh voltage potential 6.0V) to maintain the locking device 104 unlocked. Thus, the locking system 100 may reduce the power consumption and increase the operation expectancy of the locking system 100.

The signals generated by the micro-controller 208 may be configured by a user or a manufacturer. For example, a user or a manufacturer may configure various parameters of the micro-controller 208 to provide different signals (e.g., different amplitude or duty cycle) to the variable output converter 216 to unlock the locking device 104. In an exemplary embodiment, the user or manufacturer may utilize a programming card to configure various parameters of the micro-controller 208 to provide different signals to unlock the locking device 104. The user or manufacturer may configure timing, amplitude and duration of signals generated by the micro-controller 208. For example, the timing, the amplitude and the duration of the initial voltage potential, holding voltage potential and a refresh voltage potential signals generated by the micro-controller 208.

The monitoring component 222 may be integrated with the locking device 104 or a separate component from the locking device 104. The monitoring component 222 may be a door contact or a latch monitor that may monitor an unlocking time period of the locking device 104. In the event that the locking device 104 is unlocked greater than a predetermined threshold time period, the monitoring component 222 may provide an alarm signal to the control system 106 and/or the input system 102 to alert a user. In an exemplary embodiment, the alarm signal may be provided to the micro-controller 208 of the control system 106, the micro-controller 208 may cause the input status indicator 204 to provide visual (e.g., flashing lights) or audio (e.g., beeping) signal to alert the user. In another exemplary embodiment, the alarm signal may be provided directly to the input status indicator 204 of the input system 102 and the input status indicator 204 may provide visual (e.g., flashing lights) or audio (e.g., beeping) signal to alert the user.

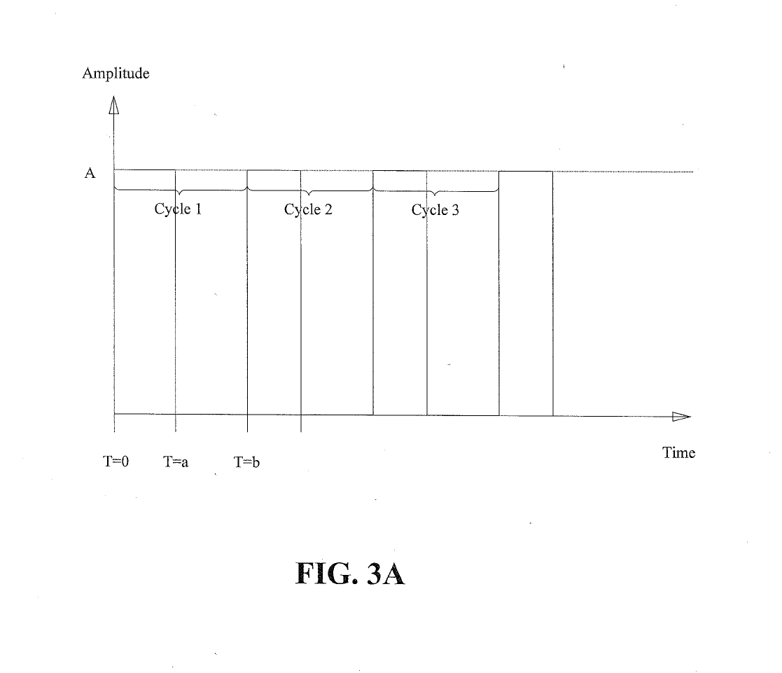

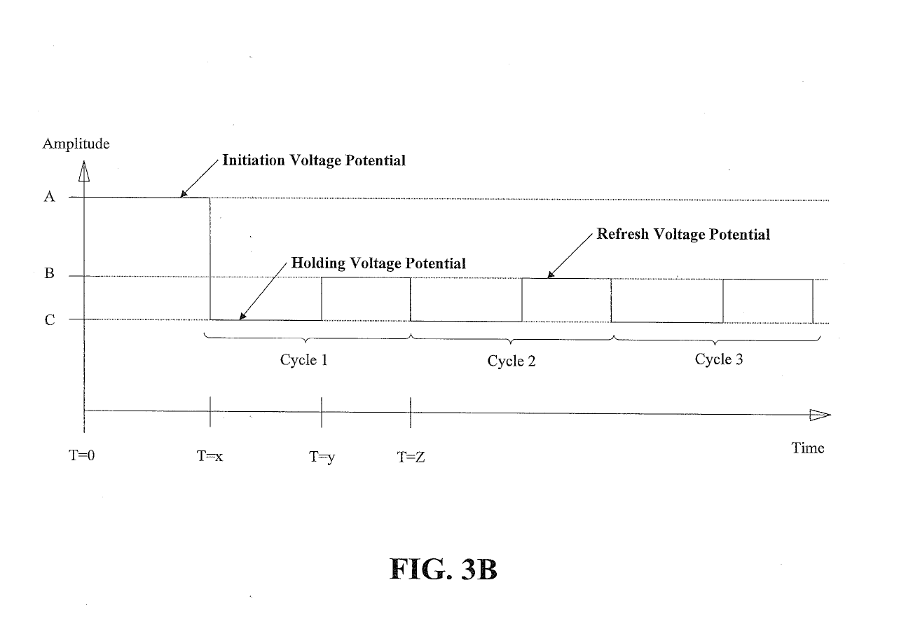

FIG. 3A illustrates an output voltage potential waveform of the micro-controller 208 according to an exemplary embodiment of the present disclosure. For example, the output voltage potential of the micro-controller 208 may be a pulse-width modulation signal having amplitude A. For example, the output voltage potential of the micro-controller 208 may be modulated as a series of pulses. The micro-controller 208 may control a number of modulated pulses per an unlocked cycle (e.g., 5 seconds). Also, the micro-controller 208 may control a time period of an unlocked cycle. For example, the micro-controller 208 may control a period of the modulated pulses in order to control a time period of an unlocked cycle. The micro-controller 208 may control a time period of an unlocking cycle. As illustrated in FIG. 3A, the modulated pulse may have a pulse width of t=b and may be repeated for many cycles during the unlocked cycle. In an exemplary embodiment, the output voltage potential waveform of the micro-controller 208 may have a frequency in a range of 10 kHz to 100 kHz. By varying the duty cycle of the plurality of access signals, the micro-controller 208 may directly control the output voltage potential of the variable output converter 216. For example, the duty cycle of the modulated pulses may be defined as a ratio of “ON” time verses “OFF” time. For example, an 60% duty cycle may be delineated as 60% of the cycle may be “ON” time and 40% of the cycle may be “OFF” time. In an exemplary embodiment, the duty cycle of the modulated pulses of the micro-controller 208 may be determined by a/b.

FIG. 3B illustrates voltage potential waveform of an output of the variable output converter 216 according to an exemplary embodiment of the present disclosure. For example, an initiation voltage potential having an amplitude A (e.g., 9.0 V) may be applied to the locking device 104 by the variable output converter 216. The initiation voltage potential may be applied for a time period of X. As discussed above, the initiation voltage potential applied by the variable output converter 216 may unlock the locking device 104. Subsequently, a holding voltage potential having an amplitude C (e.g., 2V) may be applied to the locking device 104 by the variable output converter 216. The holding voltage potential may maintain the locking device 104 unlocked. The holding voltage potential may be applied for a time period of Y-X. A refresh voltage potential having an amplitude B (e.g., 6V) may be applied to the locking device 104 by the variable output converter 216. The refresh voltage potential may maintain the locking device 104 unlocked in the event that the locking device 104 may gradually return to locked. The cycle of holding voltage potential and the refresh voltage potential may be repeatedly applied to locking device 104 by the variable output converter 216 during an unlocked cycle (e.g., 5 seconds).

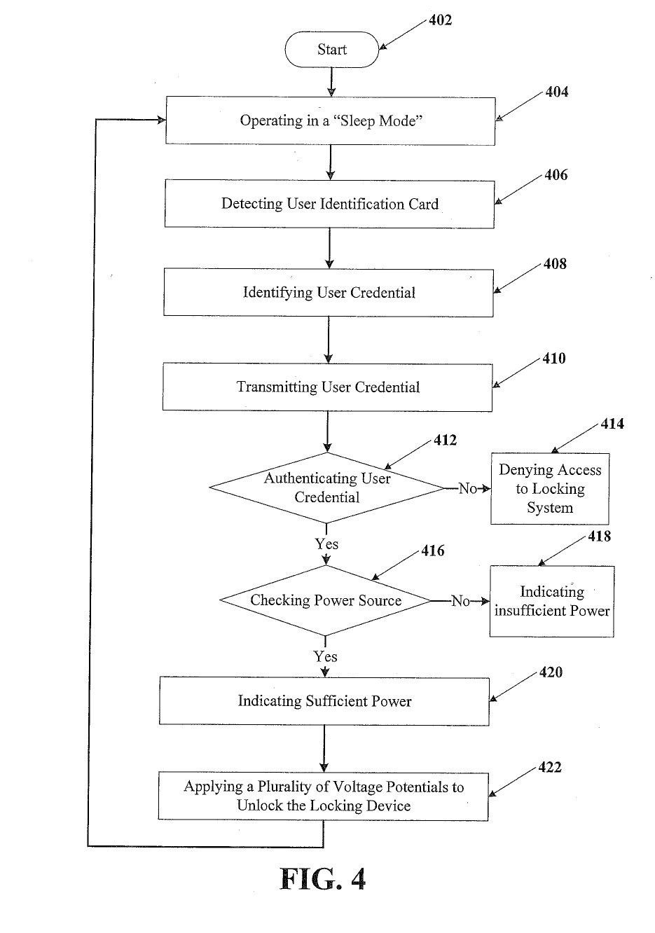

FIG. 4 illustrates a flow diagram of a method for operating the locking system 100 according to an exemplary embodiment of the present disclosure. This exemplary method 400 may be provided by way of example, as there are a variety of ways to carry out the method. The method 400 shown in FIG. 4 can be executed or otherwise performed by one or a combination of various systems. The method 400 is described below may be carried out by the systems and network shown in FIGS. 1 and 2, by way of example, and various elements of the system and component are referenced in explaining the example method of FIG. 4. Each block shown in FIG. 4 represents one or more processes, methods or subroutines carried out in exemplary method 400. Referring to FIG. 4, exemplary method 400 may begin at step 402.

At step 402, a method for operating a locking system 100 as depicted in FIG. 1 may begin.

At step 404, the locking system 100 may be in a “sleep mode.” For example, the micro-controller 208 of the control system 106 may be in a “sleep mode” in order to conserve power. The micro-controller 208 may perform no or minimum functions during the “sleep mode.” During “sleep mode,” the Wiegand interface 202 may be powered by the power source 214 in order to detect a presence of a user identification card. After the locking system 100 may be set in a “sleep mode,” the method 400 may proceed to step 406.

At step 406, a user identification card may be detected. For example, a user may attempt to access the locking device 104 and may present a user identification card to the input system 102. In an exemplary embodiment, a user may swipe the user identification card having embedded radio frequency identification (RFID) chip through a slot of the Wiegand interface 202 and thus the Wiegand interface 202 may detect a presence of the user identification card. After detecting a presence of a user identification card, the method 400 may proceed to step 408.

At step 408, user credential may be identified. Upon detection of a presence of a user identification card, the Wiegand interface 202 may identify user credential information associated with the user identification card. For example, the user credential may be represented as a binary code, a Morse code, a variable-length code, a block code, and/or any other code that may represent the user credential. In an exemplary embodiment, the user credential may be represented as a binary code and the binary code may be stored in the RFID chip of the user identification card. When the user presents the user identification card to the input system 102, the Wiegand interface 202 may identify the user credential represented by binary code. After identifying user credential, the method 400 may proceed to step 410.

At step 410, user credential may be transmitted to the micro-controller 208. For example, the Wiegand interface 202 may transmit the user credential to the micro-controller 208. The Wiegand interface 202 may transmit the user credential to the micro-controller 208 via Data 0 wire and Data 1 wire. In an exemplary embodiment, when a binary state 0 (e.g., logic low) is transmitted by the Wiegand interface 202, the Data 0 wire may be biased to a low voltage potential while the Data 1 wire may maintain the high voltage potential. When a binary state 1 (e.g., logic high) is transmitted by the Wiegand interface 202, the Data 1 wire may be biased to a low voltage potential while the Data 0 wire may maintain the high voltage potential. After transmitting the user credential to the micro-controller 208, the method 400 may proceed to step 412.

At step 412, the user credential may be authenticated. For example, the micro-controller 208 may authenticate the user credential based at least in part on user credentials stored in the memory 210. The micro-controller 208 may compare the user credential received from the Wiegand interface 202 with the valid user credentials stored in the memory 210 in order to determine whether the user credential matches a valid user credential stored in the memory 210. In the event that the received user credential does not match a valid user credential stored in the memory 210, the method 400 may proceed to step 414. In the event that the received user credential does match a valid user credential stored in the memory 210, the method may proceed to step 416.

At step 414, access to locking device 104 may be denied. The micro-controller 208 may provide a fail indication signal to the input status indicator 204 to notify the user that an access has been denied. For example, the fail indication signal may cause the input status indicator 204 to blink or beep twice to indicate a failure to authenticate the user credential. The micro-controller 208 may switch to “sleep mode” if no attempts to access the locking device 104 within a period of time (e.g., 5 seconds). Also, the micro-controller 208 may switch to “sleep mode” when the micro-controller 208 finishes performing an operation (e.g., open operation or close operation).

At step 416, the power source 214 may be checked. For example, the micro-controller 208 may determine whether the power source 214 has sufficient power to drive the variable output converter 216. For example, the micro-controller 208 may provide a power testing signal to the power source 214 via the voltage regulator 212 to determine an output power of the power source 214. The micro-controller 208 may determine whether the output power of the power source 214 meets a minimum threshold operating voltage potential to drive the variable output converter 216. In the event that the micro-controller 208 determines that the power source has low power to drive the variable output converter 216, the method 400 may proceed to step 418. In the event that the micro-controller 208 determines that the power does have sufficient power to drive the variable output converter 216, the method 400 may proceed to step 420.

At step 418, low power of the power source 214 to unlock the locking device 104 may be indicated. For example, the micro-controller 208 may provide a low power signal to the status indicator 204 to indicate that the power source 214 has low power to drive the variable output converter 216 to unlock the locking device 104. For example, the status indicator 204 may blink or beep four times to indicate low power of the power source 214 to unlock the locking device 104.

At step 420, sufficient power to unlock the locking device 104 may be indicated. For example, the micro-controller 208 may provide a sufficient power signal to the status indicator 204 to indicate that the power source 214 has sufficient power to drive the variable output converter 216 to unlock the locking device 104. For example, the status indicator 204 may blink or beep once to indicate sufficient power to unlock the locking device 104. After indicating sufficient power to unlock the locking device 104, the method 400 may proceed to block 420.

At step 422, a plurality of voltage potentials may be applied to unlock the locking device 104. For example, micro-controller 208 may provide a plurality of signals to the variable output converter 216 in order to generate a plurality of output voltage potentials that may be applied to the locking device to unlock the locking device 104. The micro-controller 208 may provide a plurality of signals to the variable output converter 216 in order to control an unlocking time period of the locking device 104. In an exemplary embodiment, the micro-controller 208 may provide a plurality of pulse-width modulation (PWM) signals to the variable output converter 216 in order to unlock the locking device 104. The plurality of signals provided by the micro-controller 208 may control an output voltage potential of the variable output converter 216 in order to reduce power consumption. For example, the micro-controller 208 may control a duty cycle of the plurality of signals provided to the variable output converter 216. In an exemplary embodiment, the plurality of signals provided by the micro-controller 208 may have a frequency in a range of 10 kHz to 100 kHz. By varying the duty cycle of the plurality of signals, the micro-controller 208 may directly control the output voltage potential of the variable output converter 216.

The variable output converter 216 may generate three different voltage potentials during an unlocked cycle (e.g., 5 seconds) based at least in part on the signals provided by the micro-controller 208. For example, the variable output converter 216 may generate an initiation voltage potential and provide the initiation voltage potential to the locking device 104. The initiation voltage potential may unlock the locking device 104 (e.g., an unlocked state). The variable output converter 216 may also generate a holding voltage potential and provide the holding voltage potential to the locking device 104. The holding voltage potential may maintain the locking device 104 in the unlocked state. The variable output converter 216 may further generate a refresh voltage potential to restore the locking device 104 in the unlocked state. For example, during the application of the holding voltage potential, the locking device 104 may gradually return to a locked state and the variable output converter 216 may provide the refresh voltage potential to restore the locking device 104 to the unlocked state. After applying a plurality of voltage potentials to unlock the locking device 104, the method 400 may return to step 404 in a “sleep mode.”

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A locking system, comprising:
an input system configured to detect a user credential;
a control system configured to authenticate the user credential and generate a plurality of signals based at least in part on an authentication of the user credential;
a driver system configured to generate a plurality of voltage potentials during an unlocking cycle based at least in part on the plurality of signals, wherein each of the plurality of voltage potentials are different from each other; and
a locking device configured to lock or unlock based at least in part on the plurality of voltage potentials.

2. The locking system of claim 1, wherein the input system comprises a Wiegand interface that is configured to detect the user credential and coupled to the control system via a Data 0 wire and a Data 1 wire to transmit the user credential.

3. The locking system of claim 1, wherein the plurality of signals are generated to adjust a length of the unlocking cycle.

4. The locking system of claim 3, wherein the plurality of signals are generated based at least in part on at least one of the following: dual in-line package (DIP) switches, programming cards or a potentiometer.

5. The locking system of claim 1, wherein the control system comprises a micro-controller configured to determine whether the user credential matches a valid user credential stored in a memory in order to authenticate the user credential.

6. The locking system of claim 5, wherein the memory stores access information of the locking device.

7. The locking system of claim 1, wherein the control system comprises a telecommunication circuitry to delete the user credential or add one or more new user credential.

8. The locking system of claim 1, wherein the locking device comprises a monitoring component to monitor an unlocking time period of the locking device.

9. The locking system of claim 8, wherein the monitoring component comprises at least one of the following door contacts or latch monitor.

10. The locking system of claim 8, wherein monitoring component generates an alarm signal when the unlocking time period exceeds a predetermined threshold time period.

11. The locking system of claim 1, wherein the control system comprises a power source having an energy harvesting circuitry.

12. The locking system of claim 1, wherein the control system comprises a power source having a super capacitor.

13. A method for operating a locking system, comprising:
detecting a presence of a user identification card having a user credential;
authenticating, via a processor, the user credential;
generating a plurality of signals based at least in part on an authentication of the user credential;
generating, via a micro-controller, a plurality of voltage potentials during a locking cycle or an unlocking cycle based at least in part on the plurality of signals, wherein each of the plurality of voltage potentials are difference from each other; and
unlocking or locking a lock device based at least in part on the plurality of voltage potentials.

14. The method of claim 13, wherein the plurality of voltage potentials comprise an initiation voltage potential, a holding voltage potential and a refresh voltage potential.

15. The method of claim 13, wherein the plurality of signals are generated to adjust a length of the unlocking cycle.

16. The method of claim 15, wherein the plurality of signals are generated based at least in part on the following: dual in-line package (DIP) switch, programming cards, or a potenitometer.

17. The method of claim 13, further comprises deleting or adding user credentials stored a memory via a telecommunication circuitry.

18. The method of claim 13, further comprises storing access information of the locking device.

19. The method of claim 13, further comprises modifying parameters of the processor in order to configure the plurality of signals.

20. The method of claim 13, further comprises monitoring a time period of the unlocking cycle of the locking device.
